(19) United States
(12) Patent Application Publication
(10) Pub. No.: US 2008/0186512 A1
(43) Pub. Date: Aug. 7, 2008

(54) Apparatus and Method for Measuring Curvature Using Multiple Beams

(76) Inventors: Bong Kee, Seoul (KR); Eui-Joon Yoon, Seoul (KR)

Correspondence Address: LADAS & PARRY LLP, 224 SOUTH MICHIGAN AVENUE, SUITE 1600, CHICAGO, IL, 60604, US

(21) Appl. No.: 11/995,561

(22) PCT Filed: Aug. 1, 2006
(86) PCT No.: PCT/KR06/03012

§ 371 Date: Jan. 14, 2008

(30) Foreign Application Priority Data
Aug. 1, 2005 (KR) 10-2005-0070265
Jun. 9, 2006 (KR) 10-2006-0052025

(51) Int. Cl. G01B 11/14; G01B 11/24

(52) U.S. Cl. 356/610; 356/615

(57) ABSTRACT

There is provided a curvature measuring apparatus and method using multiple beams. m×n multiple beams generated by an m×n laser diode (LD) array or an m×n vertical cavity surface emitting laser array having a uniform pitch are converted into multiple divergent or multiple parallel beams. The multiple beams strike and reflect from the surface of a thin film formed on a substrate Then, the multiple beams are detected by an m×n spot array in a detector such as a charge coupled device (CCD) or a CMOS image sensor. The spot spacing between the beams in the array is measured in a direction parallel to the incident plane. The spot spacing between the beams is changed by the curvature of the substrate in the direction parallel to the incident plane and the curvature may be expressed by a function including change in beam spacing, an incident angle, a distance between the surface of the thin film and the detector. These values can be measured and the curvature of the surface of the thin film can be obtained from these values. Since an m×n two-dimensional spot array is used, it is possible to obtain a two-dimensional curvature profile of the surface of the thin film.

### TECHNICAL FIELD

The present invention relates to a technology of measuring the curvature of a substrate and the stress of a thin film formed on the substrate, and more particularly, to an apparatus and method for measuring the curvature of a substrate using multiple beams for the purpose of calculating the stress of a thin film.

### BACKGROUND ART

When a thin film such as a semiconductor epitaxial layer is grown, large stress occurs in the thin film, which changes the property of the thin film. The undesirable change in stress may occur in any stage of the thin film fabrication process. The stress can cause the deterioration of a device performance, the failure of an interconnection or the strip of the thin film. Accordingly, in order to achieve desired optical, electric and mechanical properties of the thin film, the thin film stress must be measured and controlled.

In general, the stress of the thin film is intimately associated with a thin film growth mechanism, a grown microstructure and a thin film deposition condition. The stress occurs by various factors such as thermal stress due to a difference between the thermal expansion coefficients of the thin film and an underlying film (substrate or a thin film which is formed on the substrate in a previous step), a lattice mismatch stress due to a difference between lattice parameters and inherent stress associated with the microstructure of the thin film.

Accordingly, the accurate measurement of the stress is of importance in controlling a deformation degree and manufacturing a good device as well as in studying the structural characteristics of a thin film. More specifically, when the change in stress according to the growth of the thin film is observed in real time, various pieces of information on the growth of the thin film can be obtained. Accordingly, it is possible to control the property of the thin film in a strict sense and to cope with the requirement such as a process condition modification.

As a conventional method of measuring the stress, there are disclosed a method of using X-ray and a curvature-based method of measuring the curvature of a substrate using a laser beam. Since the method using the X-ray uses a lattice diffraction phenomenon, the method is hard to apply to every thin film. In addition, there is a difficulty in quantification when the stress is measured in real time. The curvature-based method includes scanning the surface with a single or a pair laser beams and a method using parallel laser beams produced by a single laser beam with etalons.

In the scanning method with a single laser beam, the laser beam strikes a substrate and change in reflection angle which depends on the curvature of the substrate is then measured using a position sensitive detector. A biaxially-stressed film exerts forces on its substrate, creating biaxial stress in the substrate, as well as exerting bending moment that curves the substrate. The mean biaxial film stress s can be determined by measuring the radius of curvature R of the substrate. When the thickness h_{f} of a thin film is much thinner than the thickness hₛ of the substrate, the mean biaxial film stress s is related to the curvature 1/R of the substrate by Equation 1

$$σ = \frac{{M}_{s} {h}_{s}^{2}}{6 {h}_{f} R} \qquad ( 1 )$$

where Mₛ is the substrate biaxial modulus.

Equation 1, often called Stoney's equation (Stoney GG: The tension of metallic films deposited by electrolysis. Proc. R. Soc. London, A: 82 [1909] 172-175) is the central relation connecting substrate curvature to film stress.

The scanning method with a laser beam is widely used as the conventional curvature measuring method. However, since this method measures the curvature while moving the laser beam on the wafer, this method is apt to be influenced by external vibration or noise during the measurement. In addition, since alignment is difficult, remote measurement is hard to be performed. Since the single laser beam scanning method is hard to be performed with a view port of a reactor chamber for growing thin films, real-time measurement is difficult.

In the method using the conventional parallel laser beams, a single laser beam passes through two etalons to form two dimensional multiple parallel beams and the multiple parallel beams strike the substrate. The number of beams and the spacing between the beams can be controlled by rotating the etalons. The image of the multiple parallel beams reflected from the surface of the substrate is measured by a charge coupled device (CCD). When stress occurs in the thin film, the substrate located below the thin film is curved. Accordingly, the curvature of the substrate finely changes the positions of the beams in the CCD image. The CCD simultaneously measures relative change in spot spacing and converts the relative change into the curvature and the stress of the thin film.

In such a curvature measuring method, since the relative positions of all the laser beams are simultaneously measured, the change in spacing between spots necessary for measuring the curvature is less influenced by the external change such as vibration. In addition, the stress can be measured in real time.

However, as the single laser beam is repeatedly transmitted to and reflected from the both sides of the etalon to form the parallel beams, the intensity of the beams gradually weakens. In order to minimize the intensity difference among multiple beams, the etalon is coated with 90% reflectivity on both sides. Since one etalon has two high reflective surfaces, the intensity of the laser beam which passes through the two etalons and strikes a sample is 1/10000. This is because the intensity of the laser beam is reduced by 90% whenever the laser beam passes through each of four reflective surfaces. Accordingly, very large power loss is generated in a second-order beam or a third-order beam.

When the substrate rotates at a high speed in some reactors so as to improve the uniformity in the thin film deposition and when the reflectivity of the sample is small, the shutter speed of the CCD must be increased. In this case, the measurement may be impossible due to the limited laser output.

### DISCLOSURE OF INVENTION

### Technical Problem

An object of the present invention is to provide an apparatus and method which can measure the curvature of a substrate in real time and efficiently measure the stress of a thin film on the substrate.

### Technical Solution

According to an aspect of the present invention, there is provided a curvature measuring apparatus including: an m×n light source array which generates m×n multiple beams incident to the surface of a sample, m and n being 1 to 100, respectively; and a detector which measures change in spot spacing of the m×n multiple beams reflected from the surface of the sample.

A calculator for obtaining the curvature of the sample and the stress using the change in spot spacing may be further included. The detector itself may be configured to obtain the curvature of the sample and the stress.

The m×n light source array may be any one of an m×n laser diode (LD) array and an m×n vertical cavity surface emitting laser (VCSEL) array having a uniform pitch.

The curvature measuring apparatus may convert the m×n multiple beams into m×n multiple slightly divergent beams or m×n multiple parallel beams, which are used in measuring the curvature. Accordingly, the curvature measuring apparatus may further include a single collimating lens unit which converts the m×n multiple beams into the m×n slightly divergent beams and strikes the m×n divergent beams to the surface of the sample or an m×n micro collimating lens array which converts the m×n multiple beams into the m×n parallel beams and strikes the m×n parallel beams to the surface of the sample.

The single collimating lens unit preferably includes at least one aspherical optical lens. The single collimating lens unit may further include a focusing lens.

The m×n multiple beams may strike the surface of the sample at an incident angle having a range of from equal to or more than 0° to less than 90°. When the m×n multiple beams strike the surface of the sample at normal incidence, it is preferable that a beam splitter which splits the m×n multiple beams reflected from the surface of the sample at a right angle from the incident m×n multiple beams is further included.

The detector may be any one of a charge coupled device (CCD) and a CMOS image sensor (CIS).

According to another aspect of the present invention, there is provided a curvature measuring method including: collimating m×n multiple beams generated by an m×n light source array; striking the m×n multiple beams to the surface of a sample, m and n being 1 to 100, respectively; measuring changes in spot spacing of a spot array of the m×n multiple beams reflected from the surface of the sample by a CCD or a CMOS image sensor for measuring the m×n spot array; and obtaining the curvature of the sample and the stress using the change in spot spacing.

In the step of measuring the changes in spot spacing of the spot array by CCD or CIS, the change in spot spacing in the direction parallel to the incident plane is measured to obtain the curvature and the stress of the thin film.

In the curvature measuring apparatus and method according to the present invention, the curvature of the sample such as a substrate is measured using the reflection of the multiple divergent beams or the multiple parallel beams. Whereas a single beam is converted into multiple parallel beams using an etalon in the conventional multiple parallel beam method, the m×n light source array is used in the present invention. That is, the m×n multiple beams generated by m×n VCSEL array or the m×n LD array are converted to the m×n divergent beams using the single collimating lens unit or to the m×n parallel beams using the m×n micro collimating lens array. The LD outputs elliptical beams. Accordingly, when m×n LD array is used, the elliptical beams must be converted into circular beams using a micro lens array. The multiple beams incident to and reflected from the thin film formed on the substrate at an incident angle a (from equal to or more than 0° to less than 90°) are converted into an m×n spot array by the detector.

The directions of the m×n spot array are defined to x and y directions. The x direction is parallel to the incident plane of laser beams and the y direction is perpendicular to the incident plane of laser beams. The plane formed by incident beams and the normal of the substrate is the incident plane and the direction of a straight-line formed by the incident plane and the substrate is a direction (x direction) parallel to the incident plane. The direction perpendicular to the straight line formed by the incident plane and the substrate on the substrate is the direction perpendicular to the incident plane, that is, the y direction.

The spot spacing of the spot array in the x direction is measured using the detector. When the curvature of the substrate is changed, the reflection angle of each of the multiple beams is changed and thus the spot spacing is changed. By measuring the changes in spot spacing in the x direction parallel to the incident plane, it is possible to obtain the curvature of the substrate. Since the m×n multiple beams are simultaneously measured, this method is less sensitive to vibration.

### Advantageous Effects

The curvature measuring apparatus according to the present invention has a simpler structure than the conventional apparatus. In order to apply the apparatus for measuring the curvature or the stress in real time to thin film deposition equipments, the reduction in size of the curvature measuring apparatus is a critical technical issue. In the present invention, it is possible to reduce the size of the curvature measuring apparatus to a palm size by using the VCSEL array or the LD array by removing complicated mechanical structures and optical parts used in the multiple beam method using etalons or in the laser scanning system.

According to the present invention, since an m×n light source array (an m×n VCSEL array or an m×n LD array) is used to obtain multiple beams, the intensity of the laser beam is not reduced unlike the conventional curvature measuring method using the high-reflectivity etalon. When the conventional high-reflectivity etalon is used, the laser beam of which the intensity is reduced to 1/10000 or less strikes the substrate. Even if the intensity of the laser beam of the m×n light source array used in the embodiment of the present invention is 1/10000 of the conventional intensity of the laser beam, curvature measurement can be made. That is, even if the VCSEL array or the LD array having power lower than that of the prior art is used, it is possible to efficiently measure the stress.

The resolution of the conventional curvature measuring method is limited by the number of useful laser beams generated by using an etalon since the intensities of the higher order beams decrease progressively. On the other hand, in the present invention, the intensities of m×n multiple beams are identical and the number of multiple beams can be increased to reasonable numbers, depending on applications. Much larger number of multiple beams in measuring the changes in spot spacing is very crucial in significantly improving the resolution of the present invention, compared with the conventional curvature measuring method.

Since the same view port is used with respect to the incident beam and the reflected beam in the method, the curvature measuring method is applicable to a reactor having a view port having a small size (diameter) of 10 mm.

### DESCRIPTION OF DRAWINGS

The above and other features and advantages of the present invention will become more apparent by describing in detail exemplary embodiments thereof with reference to the attached drawings in which:

FIG. 1 is a schematic of a curvature measuring apparatus using multiple divergent beams according to a first embodiment of the present invention;

FIG. 2 is a diagram a 5×4 vertical cavity surface emitting laser (VCSEL) array;

FIG. 3 is a diagram of the geometry of divergent beams reflecting from a curved surface of a substrate;

FIG. 4 is a schematic of a curvature measuring apparatus using normal incidence multiple divergent beams according to a second embodiment of the present invention;

FIG. 5 is a schematic of a curvature measuring apparatus using multiple parallel beams according to a third embodiment of the present invention;

FIG. 6 is a diagram of CCD image of two dimensional multiple beams falling upon the detector after reflected from a sample surface;

FIG. 7 is a diagram of the geometry of parallel beams reflecting from a curved surface of a substrate; and

FIG. 8 is a schematic of a curvature measuring apparatus using normal incidence multiple parallel beams according to a fourth embodiment of the present invention.

### MODE FOR INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the shapes of elements are exaggerated for clarity. Like reference numerals in the drawings denote like elements, and thus their description will be omitted.

### FIRST EMBODIMENT

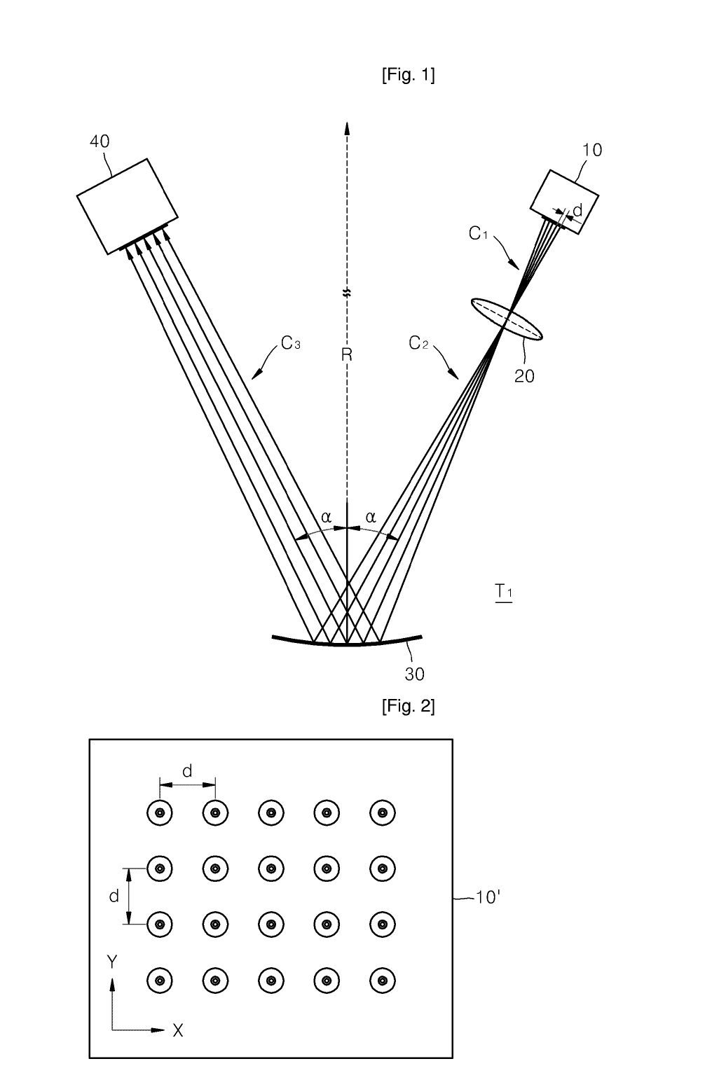

FIG. 1 is a schematic view of a curvature measuring apparatus T₁ using m×n multiple divergent beams according to a first embodiment of the present invention (here, m and n are from 1 to 100, respectively).

A reference numeral 10 of FIG. 1 is an m×n light source array which is any one of an m×n laser diode (LD) array and an m×n vertical cavity surface emitting laser (VCSEL) array having a pitch d. The m×n light source array 10 generates m×n laser beams C₁. FIG. 2 shows a 5×4 VCSEL array 10′ having a uniform pitch d. X direction correspond to the direction parallel to the incident plane of laser beams and Y direction correspond to the direction perpendicular to the incident plane of lasers beams.

The m×n laser beams C₁ generated by the m×n light source array 10 is collimated by a single collimating lens unit 20 to form m×n multiple divergent beams C₂. The single collimating lens unit 20 includes at least one aspherical optical lens for reducing aberration. The single collimating lens unit 20 may further include a focusing lens.

The m×n multiple divergent beams C₂ are incident on a substrate 30 of a sample at an incident angle a (from equal to or more than 0° to less than 90°) and m×n multiple beams C₃ reflected from the surface of the substrate 30 fall upon a detector 40. The reflected multiple beams C₃ are detected as an m×n spot array in the detector 40 and the detector 40 or a calculator (not shown) connected to the detector 40 measure the curvature of the substrate 30 and the stress from the change in spot spacing along the X direction which is parallel to incident plane of the reflected m×n multiple beams C₃. The detector 40 may be a charge coupled device (CCD), a CMOS image sensor (CIS) or an array detector.

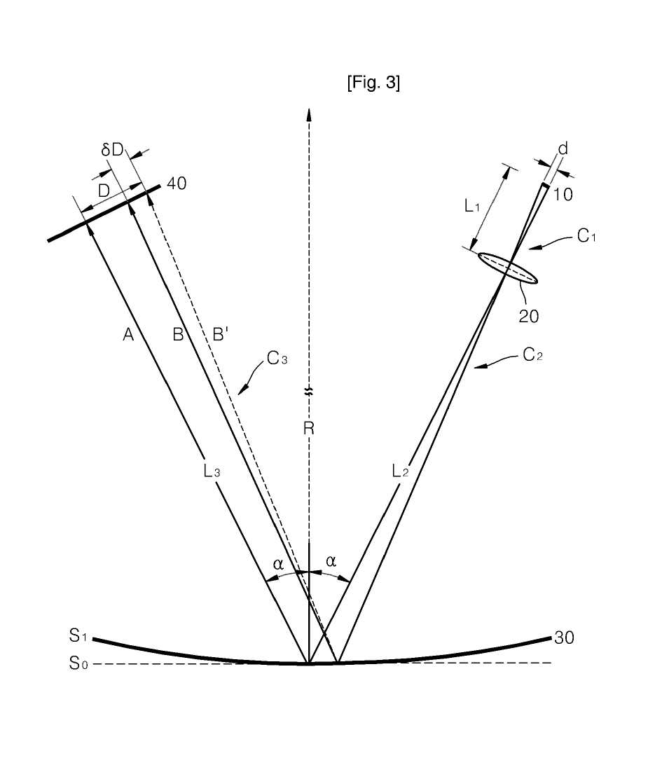

FIG. 3 is a view showing a geometry when the multiple divergent beams C₂ are reflected from the curved surface of the substrate 30 with the curvature 1/R in the curvature measuring apparatus T₁ shown in FIG. 1 and showing a relationship between the curvature of the substrate and the deflection of the laser beam.

A reference character R denotes the radius of curvature of substrate 30, L₁ denotes a distance between the m×n light source array 10 and the center of the single collimating lens unit 20, L₂ denotes a distance between the center of single collimating lens unit 20 and the center or vertex of the curved substrate 30, and L₃ denotes a distance between the center or vertex of the substrate 30 and the sensing plane of detector 40. A reference character d denotes the pitch of the VCSEL array or the LD array used as the light source array 10 and a (from equal to or more than 0° to less than 90°) denotes the incident angle.

A reference character D denotes the spot spacing of the m×n multiple beams C₃ on the detector which are reflected from a flat surface S₀ and detected by the detector 40 (distance between the spots of a beam A and a beam B′ among the multiple divergent beams C₃ on the detector 40) and d D denotes the change in spot spacing in the direction parallel to incident plane of the multiple beams C₃ which are reflected from a curved surface S₁ of the substrate 30 and detected by the detector 40.

At this time, the curvature (1/R) of the surface S₁ is expressed by Equation 2.

### Equation 2

$$\frac{1}{R} = \frac{{tan}^{- 1} ( \frac{\begin{matrix}δ D + \{ {L}_{3} + {L}_{2} [ sin α - cos α \cdot \\ tan ( α - \frac{d}{{L}_{1}} ) ] \cdot sin α \} \cdot tan \frac{d}{{L}_{1}}\end{matrix}}{{L}_{3} + {L}_{2} [ sin α - cos α \cdot tan ( α - \frac{d}{{L}_{1}} ) ] \cdot sin α} ) - \frac{d}{{L}_{1}}}{2 {L}_{2} [ sin α - cos α \cdot tan ( α - \frac{d}{{L}_{1}} ) ]} \qquad ( 2 )$$

The measurement sensitivity of the curvature (1/R) is determined by the measurement precision of the spot spacing. Since all the values d D, a, d, L₁, L₂ and L₃ can be measured, it is possible to obtain relatively easily the curvature (1/R). By combining Equation 2 and Equation 1, it is possible to calculate the stress of the thin film.

In the conventional etalon method, if a single LD module is used as the light source, elliptical beams must be converted into circular beams using a separate optical system so as to be used in measuring the curvature. The converted circular beams are diffraction limited circular beams. However, the VCSEL used in the present embodiment generates high-quality circular beams. When the LD array is used, a microlens for converting elliptical beams into circular beams is used in each of LD cells.

### SECOND EMBODIMENT

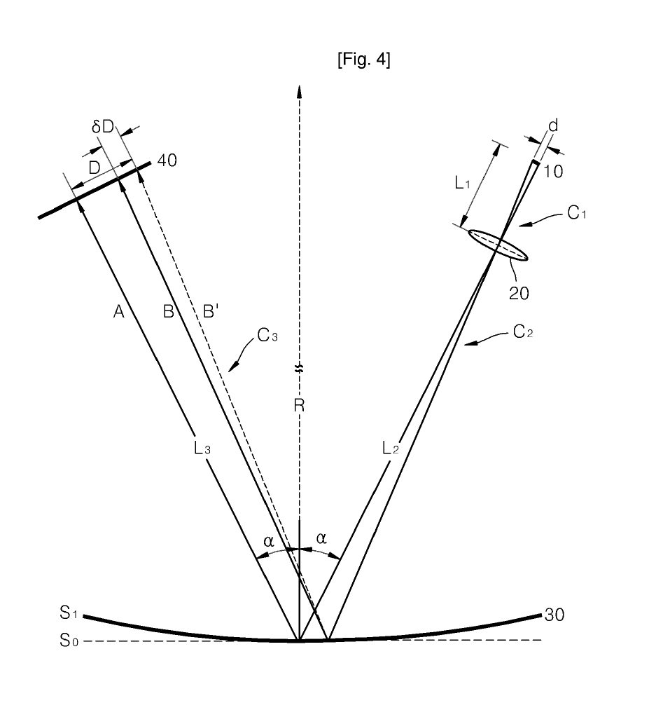

FIG. 4 is a schematic view of a curvature measuring apparatus T₂ which strikes m×n multiple divergent beams at normal incidence according to a second embodiment of the present invention.

First, an m×n light source array 110 which is any one of an m×n LD array and an m×n VCSEL array having a pitch d generates m×n laser beams D₁.

A single collimating lens unit 120 receives the m×n laser beams D₁ and generates m×n multiple divergent beams D₂ having a uniform divergence angle. The single collimating lens unit 120 includes at least one aspherical optical lens for reducing aberration. The single collimating lens unit 120 may further include a focusing lens.

Next, the m×n multiple divergent beams D₂ are incident on the surface of a substrate 130 through a beam splitter 160 at normal incidence.

The beam splitter 160 splits m×n multiple beams D₃ reflected from the surface of the substrate 130 at a right angle from the incident beams D₂. The split m×n multiple beams D₃ fall upon a detector 140, which measures the spot spacing in the direction parallel to incident plane of the reflected m×n multiple beams D₃ to obtain the curvature of the substrate 130. The detector 140 may be a CCD, a CIS or an array detector.

A method of obtaining the curvature of the substrate 130 from the change in spot spacing can use Equation 2. At this time, it is preferable that the changes in spot spacing in the direction (x direction) parallel to an incident plane is measured.

In the present embodiment, since the multiple beams fall upon the substrate at normal incidence, the incident angle a is substantially 0°. Accordingly, in Equation 2, cos a is 1 and sin a is 0. The radius of curvature R of the thin film obtained using Equation 2 is combined to Equation 1 to obtain the stress s of the thin film which is grown on the substrate.

Since the same view port is used with respect to the incident beam and the reflected beam in the apparatus and the method which strikes the beams at normal incidence, the curvature measuring method is applicable to a reactor having a view port with a small diameter of 10 mm. Since m×n two-dimensional spot array is used, it is possible to obtain a two-dimensional curvature profile of the surface of the substrate.

In the first and second embodiments, the apparatus and method for measuring the curvature and the stress using the multiple divergent beams was described. Hereinafter, an apparatus and method for measuring curvature and stress using multiple parallel beams will be described.

### THIRD EMBODIMENT

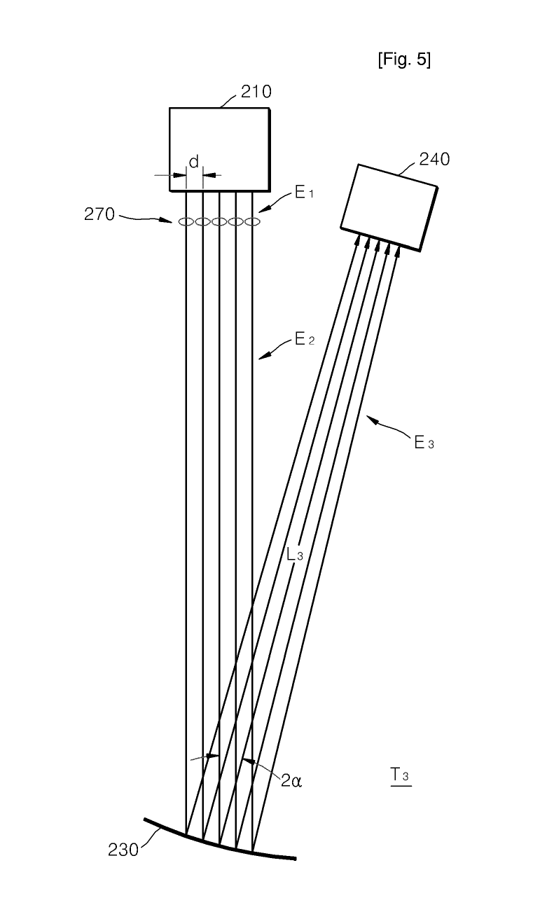

FIG. 5 is a schematic view of a curvature measuring apparatus T₃ for forming m×n multiple parallel beams using an m×n microlens array and measuring curvature according to a third embodiment of the present invention.

A reference numeral 210 of FIG. 5 is an m×n light source array which is any one of an m×n LD array and an m×n VCSEL array having a pitch d. The LD array outputs elliptical beams. Accordingly, when the m×n LD array is used, the elliptical beams must be converted into circular beams using a micro lens array.

The m×n light source array 210 generates m×n laser beams E₁ and the m×n laser beams E₁ are converted into m×n multiple parallel beams E₂by an m×n micro collimating lens array unit 270. The laser beams generated by the m×n light source array 210 is converted into parallel laser beams using a micro collimating lens array.

The m×n multiple parallel beams E₂ are incident on surface of a substrate 230 at an incident angle a (from equal to or more than 0° to less than 90°) and m×n multiple beams E₃ reflected from the surface of the substrate 230 fall upon a detector 240. The detector 240 measures the curvature of the substrate 230 from the change in spot spacing in the direction parallel to incident plane of the m×n multiple beams E₃. The detector 240 may be a CCD, a CIS or an array detector.

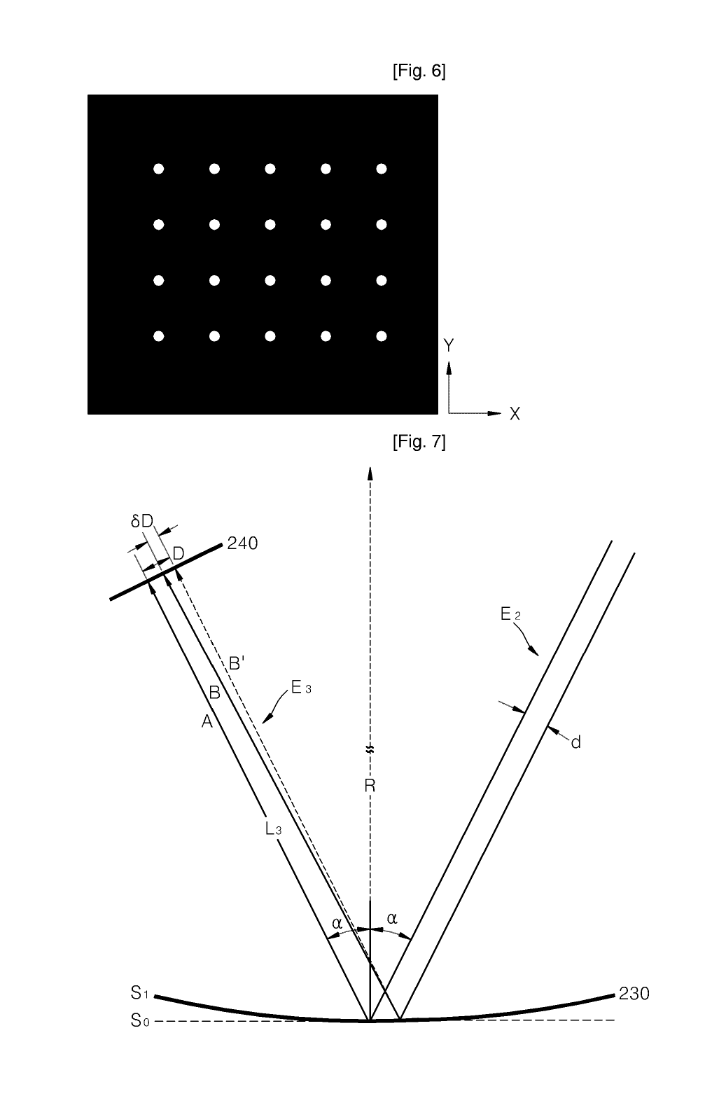

When the CCD is used as the detector 240, an x-y two-dimensional spot image array shown in FIG. 6 is displayed on a screen by capturing the spot image. The distance between adjacent spots is changed sensitively to the change in curvature of the substrate.

FIG. 7 is a view showing a geometry when the m×n multiple parallel beams E₂ are reflected from the surface of the substrate 230 having the curvature using the curvature measuring apparatus T₃ shown in FIG. 5 and showing a relationship between the curvature of the substrate and the deflection of the laser beam.

A reference character R denotes the radius of curvature of substrate 230, L₃ denotes a distance between the center or vertex of the substrate 230 and the detector 240. A reference character d denotes the pitch of the m×n VCSEL array or the m×n LD array used as the m×n light source array 210 and a (from equal to or more than 0° to less than 90°) denotes the incident angle.

A reference character D (D=d, since the parallel beams are used) denotes the spot spacing in the detector of the m×n multiple beams E₃ which are reflected from a flat surface S₀ and detected by the detector 240 (distance between the spots of a beam A and a beam B′ among the multiple parallel beams E₃ on the detector 40) and d D denotes the change in spot spacing in the direction parallel to incident plane of the m×n multiple beams E₃ which are reflected from a curved surface S₁ of the substrate 230 and detected by the detector 240.

At this time, the curvature (1/R) of the surface S₁ is expressed by Equation 3, similar to Equation 2.

### Equation 3

$$\frac{1}{R} = \frac{cos α \cdot {tan}^{- 1} ( \frac{δ D}{{L}_{3}} )}{2 d} \qquad ( 3 )$$

The measurement sensitivity of the curvature (1/R) is determined by the measurement precision of the spot spacing. Since all the values d D, a, and L₃ can be measured, it is possible to obtain the curvature (1/R). By combining Equation 3 and Equation 1, it is possible to calculate the stress of the thin film.

### FOURTH EMBODIMENT

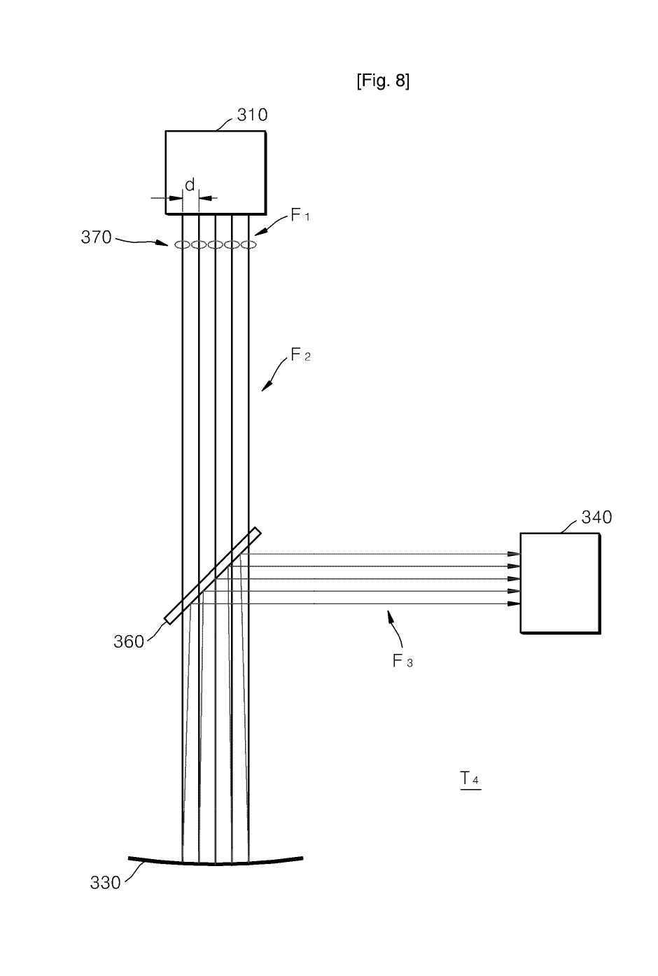

FIG. 8 is a schematic view of a curvature measuring apparatus T₄ which strikes m×n multiple parallel beams at normal incidence according to a fourth embodiment of the present invention.

First, an m×n light source array 310 generates m×n laser beams F₁. The m×n light source array 310 is any one of an m×n LD array and an m×n VCSEL array having a pitch d.

An m×n micro collimating lens unit 370 receives the m×n laser beams F₁ and generates m×n multiple parallel beams F₂ The laser beams generated by the m×n light source array 310 is converted into parallel laser beams using a micro collimating lens array.

The LD array outputs elliptical beams. Accordingly, when the m×n LD array is used, the elliptical beams must be converted into circular beams using a micro lens array.

Next, the m×n multiple parallel beams F₂ fall upon a substrate 330 through a beam splitter 360 at normal incidence.

The beam splitter 360 splits m×n multiple beams F₃ reflected from the surface of the substrate 330 at a right angle from the incident m×n multiple parallel beams F₂. The split m×n multiple beams F₃ fall upon a detector 340, which measures the spot spacing of the reflected m×n multiple beams F₃ to obtain the curvature of the substrate 330. The detector 340 may be a CCD, a CIS or an array detector.

A method of obtaining the curvature of the substrate 330 from the change in spot spacing can use Equation 3. At this time, it is preferable that the change in spacing in a direction (x direction) parallel to the incident plane is measured.

Since the same view port is used with respect to the incident beam and the reflected beam in the method which strikes the beams at normal incidence, the curvature measuring method is applicable to a reactor having a view port having a small size (diameter) of 10 mm.

While the present invention has been particularly shown and described with reference to exemplary embodiments thereof, it will be understood by those skilled in the art that various changes in form and details may be made therein without departing from the spirit and scope of the invention as defined by the appended claims.

1. A curvature measuring apparatus comprising:
an m×n light source array which generates m×n multiple beams incident to the surface of a sample, m and n being 1 to 100, respectively; and
a detector which measures change in spot spacing of an m×n spot array of the m×n multiple beams reflected from the surface of the sample.

2. The curvature measuring apparatus according to claim 1, further comprising a single collimating lens unit which converts the m×n multiple beams generated by the m×n light source array into m×n divergent beams and strikes the m×n divergent beams to the surface of the sample.

3. The curvature measuring apparatus according to claim 1, further comprising an m×n micro collimating lens array which converts the m×n multiple beams generated by the m×n light source array into m×n parallel beams and strikes the m×n parallel beams to the surface of the sample.

4. The curvature measuring apparatus according to claim 1, wherein the m×n light source array is any one of an m×n laser diode (LD) array and an m×n vertical cavity surface emitting laser (VCSEL) array having a uniform pitch.

5. The curvature measuring apparatus according to claim 4, further comprising a single collimating lens unit which converts the m×n multiple beams generated by the m×n light source array into m×n divergent beams and strikes the m×n divergent beams to the surface of the sample.

6. The curvature measuring apparatus according to claim 4, further comprising an m×n micro collimating lens array which converts the m×n multiple beams generated by the m×n light source array into m×n parallel beams and strikes the m×n parallel beams to the surface of the sample.

7. The curvature measuring apparatus according to claim 1, wherein the m×n multiple beams strike the surface of the sample at an incident angle having a range of from equal to or more than 0° to less than 90°.

8. The curvature measuring apparatus according to claim 1, wherein the m×n multiple beams strike the surface of the sample at normal incidence using a beam splitter, and a beam splitter which splits the m×n multiple beams reflected from the surface of the sample is further included.

9. The curvature measuring apparatus according to claim 1, wherein the detector is any one of a charge coupled device (CCD) and a CMOS image sensor (CIS).

10. A curvature measuring method comprising:
striking m×n multiple beams generated by an m×n light source array to the surface of a sample, m and n being 1 to 100, respectively;
measuring changes in spot spacing of a spot array of the m×n multiple beams reflected from the surface of the sample; and
obtaining the curvature of the sample using the changes in spot spacing.

11. The curvature measuring method according to claim 10, wherein the m×n light source array is any one of an m×n laser diode (LD) array and an m×n vertical cavity surface emitting laser (VCSEL) array having a uniform pitch.

12. The curvature measuring method according to claim 10, further comprising:
striking the m×n multiple beams to the surface of the sample at normal incidence using a beam splitter, and
splitting the m×n multiple beams reflected from the surface of the sample.
